(19) United States
(12) Patent Application Publication
(10) Pub. No.: US 2015/0169511 A1
(43) Pub. Date: Jun. 18, 2015

(54) System and method for identifying floor of main body of webpage

(71) Applicant: BEIJING QIHOO TECHNOLOGY COMPANY LIMITED, Beijing (CN)

(72) Inventor: Yingying Chen, Beijing (CN)

(73) Assignee: BEIJING QIHOO TECHNOLOGY COMPANY LIMITED, Beijing (CN)

(21) Appl. No.: 14/411,005

(22) PCT Filed: Jun. 9, 2013
(86) PCT No.: PCT/CN2013/077105

§ 371 Date: Dec. 23, 2014

(30) Foreign Application Priority Data
Jun. 25, 2012 (CN) 201210214079.9

(51) Int. Cl. G06F 17/22

(52) U.S. Cl. CPC G06F 17/2247

(57) ABSTRACT

The invention discloses a system for identifying a main body of a webpage, which comprises: a webpage parse & layout module configured to parse source codes of the webpage, perform a layout calculation on the parsed result, and generate a DOM tree of the webpage; a node identification module configured to traverse starting from the root node of the DOM tree, and identify a main body node and a spam word node in the DOM tree; a floor division module configured to divide the identified main body node according to floors of the webpage; and a mobile terminal page generation module configured to generate a mobile terminal page. After the invention identifies and extracts the content of a traditional internet webpage, it may effectively extract a BBS main body, a news main body and a comment, and restore a presentation feature of “divided floors” of the content of a main body in the original webpage, of which the presentation effect maintains the original “multi-floor” feature, so as to provide a user with an excellent reading experience.

### FIELD OF THE INVENTION

The invention relates to the field of internet, and in particular, to a system and method for identifying the floor of a main body of a webpage.

### BACKGROUND OF THE INVENTION

With the development and popularization of mobile terminals, people more and more use a mobile terminal to browse a webpage. However, since most websites on the internet do not make a special treatment on the webpage presentation of a mobile terminal, deformations of the presentation of most webpages occur on the mobile terminal, which leads to an extremely poor reading experience for a user.

The current methods for improving a user's reading experience are to extract and rearrange main bodies of a webpage, and then re-present them to the user. For a news and information webpage with massive content, the effect is good, but user comments will be discarded; for a forum in which a main body is divided into multiple “floors”, etc., the effect is worse: only the main body of a certain floor can be identified, or the main body cannot be identified. Spam word information in a source webpage is not removed, and the content of the webpage does not have a fixed effect, and the effects of the generated webpage and the source webpage will appear.

### SUMMARY OF THE INVENTION

In view of the above problems, the invention is proposed to provide a system and method for identifying the floor of a main body of a webpage which overcome the above problems or at least in part solve or mitigate the above problems.

According to an aspect of the invention, there is provided a system for identifying a main body of a webpage, which comprises: a webpage parse & layout module configured to parse source codes of the webpage, perform a layout calculation on the parsed result, and generate a DOM tree of the webpage; a node identification module configured to traverse starting from the root node of the DOM tree, and identify a main body node and/or a spam word node in the DOM tree; and a floor division module configured to divide the identified main body node according to floors of the webpage.

According to another aspect of the invention, there is provided a method for identifying a main body of a webpage, which comprises: parsing source codes of the webpage, performing a layout calculation on the parsed result, and generating a DOM tree of the webpage; traversing starting from the root node of the DOM tree, and identifying a main body node and/or a spam word node in the DOM tree; and dividing the identified main body node according to floors of the webpage.

According to yet another aspect of the invention, there is provided a computer program comprising a computer readable code which causes a server to perform the method for identifying a main body of a webpage according to any of claims 15-28, when said computer readable code is running on the server.

According to still another aspect of the invention, there is provided a computer readable medium storing the computer program as claimed in claim 29 therein.

The beneficial effects of the invention lie in that:

After the invention identifies and extracts the content of a traditional internet webpage, it may effectively extract a BBS main body, a news main body and comments, and restore a presentation feature of “divided floors” of the content of a main body in the original webpage, of which the presentation effect maintains the original “multi-floor” feature, so as to provide a user with an excellent reading experience.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings:

FIG. 1 shows schematically a structure diagram of a system according to an embodiment of the invention;

FIG. 2 shows schematically a flow chart of a method according to an embodiment of the invention;

FIG. 3 shows schematically a DOM tree generated according to an embodiment of the invention;

FIG. 4 shows schematically a diagram of a mobile terminal webpage generated according to the DOM tree of FIG. 3;

FIG. 5 shows schematically a block diagram of a server for performing a method according to the invention; and

FIG. 6 shows schematically a storage unit for retaining or carrying a program code implementing a method according to the invention.

### DETAILED DESCRIPTION OF THE INVENTION

In the following the invention will be further described in connection with the drawings and the particular embodiments.

A structure diagram of a system according to an embodiment of the invention is as shown in FIG. 1.

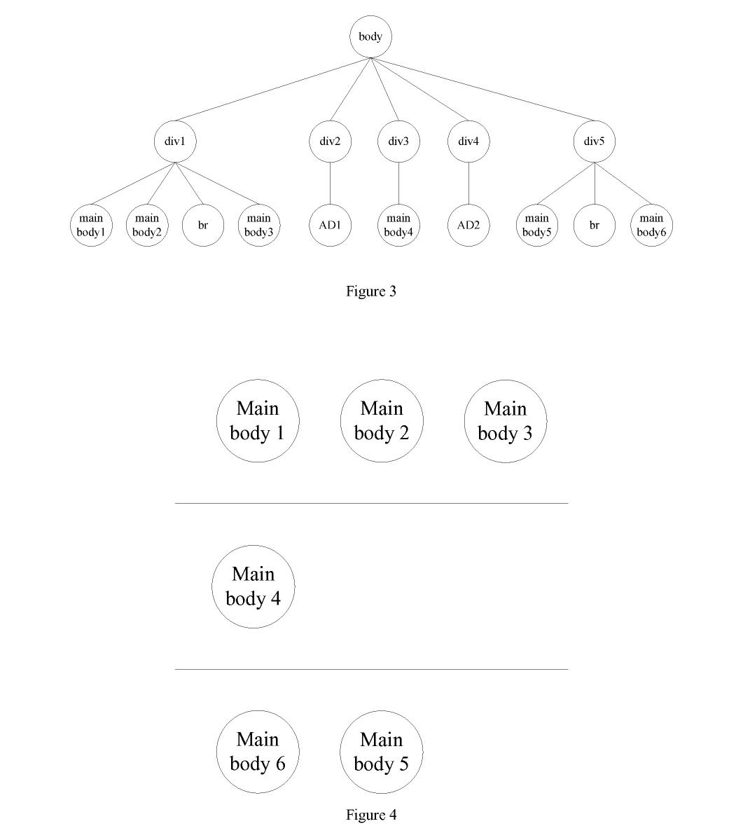

The webpage parse & layout module 100 parses and performs a layout calculation on source codes of a webpage. When parsing HTML source codes and laying out, an HTML parse engine is adopted, and a commonly used open source HTML parse engine is e.g., webkit. The parse & layout is based on a label in the source codes of the webpage, which may be based on, but not limited to, the div label, to generate a DOM tree of the webpage, and calculate the position and the height shown by individual nodes when the webpage is presented. One generated DOM tree is as shown in FIG. 3.

Since on a mobile terminal, the dynamic effect of an internet webpage is difficult to be displayed, the dynamic effect needs to be given up in the process of generating the DOM tree, and only a link to pictures and the text format of a main body are kept.

The node identification module 200 traverses the whole DOM tree starting from the body node, and identifies the main body content and the spam word content by the algorithm which can classify data rules, such as a typical decision tree algorithm.

The node identification module 200 comprises a statistics module, a comparison module and a main body identification module. First, the statistics module calculates the node distribution value, the text density and the spam word density of the page of each webpage; then, the comparison module compares the node distribution value, the text density and the spam word density with a corresponding preset threshold; and finally, the main body identification module identifies the content in the DOM tree, of which the node distribution value, the text density and the spam word density fall within the threshold, as a main body. Therein, the node distribution represents the composition of child nodes of a node, for example, the number of individual labels, such as div, img, table, etc., the proportion of the labels in the child nodes; the text density represents an average text length obtained by dividing the text length in a node by the number of its child nodes; and the spam word (non-body vocabulary) density represents a value of the division of the length of all the ad words in a node by the length of all the texts in the node. The spam word is identified based on a dictionary, and maintained manually, for example, a word and a phrase such as print preview, support, hot comments, no hot comments yet, etc., which are irrelevant to a main body in the webpage.

From the above three features, a threshold is obtained according to the decision tree algorithm, and nodes within the range of the threshold are all identified as a main body, and others are identified as spam words.

The floor division module comprises a position division module and a feature word division module.

The position division module performs a floor division and identification according to the path and positional relationship of a main body node on the DOM tree, and the rules which are based on when dividing are as follows.

1. if two main body nodes are adjacent to each other on the DOM tree, then the two nodes belong to one and the same floor.

As shown in FIG. 3, br represents a line break, and the br label is an empty label. The main body node 1 and the main body node 2 have a common father node div1, and the main body node 1 and the main body node 2 are adjacent to each other, and therefore the main body node 1 and the main body node 2 may be identified as nodes in one and the same floor.

2. if one main body node and other main body nodes which have already been determined as belonging to one and the same floor have a common father node, then these main body nodes belong to one and the same floor.

For example, the main body node 3 in FIG. 3 and the main body node 2, the main body node 1 have a common father node div1, and the main body node 2 and the main body node 1 have been determined as belonging to one and the same floor, therefore, the main body node 3 also belongs to the same floor.

3. if a common father node of two main body nodes is body, then the two main body nodes are divided into different floors.

For example, for the main body node 1 and the main body node 4, their paths in the DOM tree are respectively:

main body 1→div1→body

main body 4→div3→body

The common father node of their paths is body, and thereby they should be identified as being at different floors.

4. if the relationship between main body nodes is not comprised in the above situations, then they are divided into different floors.

The feature word division module performs a division primarily according to a feature word in a node, for example, a BBS main body or a news & information review, i.e.

the content published by the author, is presented simultaneously together with relevant information of the author, and they appear alternately, usually as follows:

author information→main body→author information→main body→author information→main body . . .

A further “floor” division is performed on a main body by identifying a key word (e.g., publish time, register time, etc.) in a non-body node indicating the information of an author.

The mobile terminal page generation module comprises a layout generation module configured to re-lay out the content of a main body node according to its divided floors, and generating a mobile terminal page. In the above process, according to the DOM tree as shown in FIG. 3, the floor distribution result of the main body nodes is as shown in FIG. 4, namely,

floor 1: main body 1, main body 2, main body 3;

floor 2: main body 4;

floor 3: main body 5, main body 6.

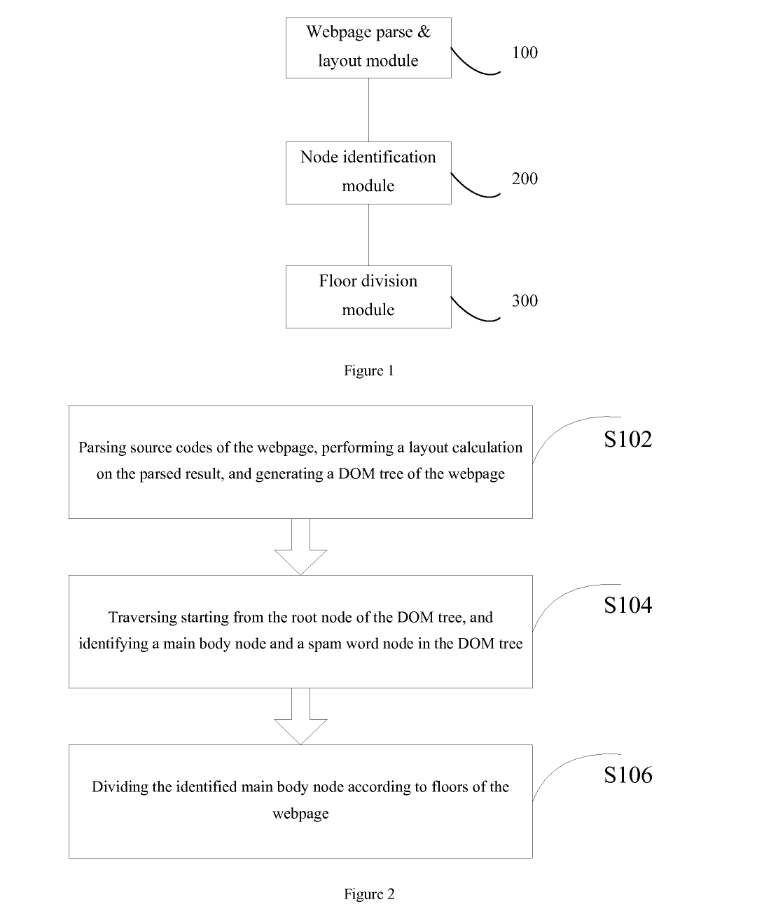

A flow chart of the method provided by the invention is as shown in FIG. 2.

S102: performing a parse & layout calculation on source codes of a webpage. When parsing HTML source codes and laying out, an HTML parse engine is adopted, and a commonly used open source HTML parse engine is e.g., webkit. The parse & layout is based on a label in the source codes of the webpage, primarily the div label, to generate a DOM tree of the webpage, and calculate the position and the height shown by individual nodes when the webpage is presented. One generated DOM tree is as shown in FIG. 3.

Since on a mobile terminal, the dynamic effect of an internet webpage is difficult to be displayed, the dynamic effect needs to be given up in the process of generating the DOM tree, and only a link to pictures and the text format of a main body are kept.

S104: traversing the whole DOM tree starting from the body node, and identifying the main body content and the spam word content, by the algorithm which can classify data rules, such as a typical decision tree algorithm.

First, the node distribution value, the text density and the spam word density of the page of each webpage are calculated; then, the node distribution value, the text density and the spam word density are compared with a preset threshold respectively; and finally, the content in the DOM tree, for which the threshold is not exceeded, is identified as a main body.

Therein, the node distribution represents the composition of child nodes of a node, for example, the number of an individual label, such as div, img, table, etc., the proportion of the labels in the child nodes; the text density represents an average text length obtained by dividing the text length in a node by the number of its child nodes; and the spam word (non-body vocabulary) density represents a value of the division of the length of all the ad words in a node by the length of all the texts in the node. The spam word is identified based on a dictionary, and maintained manually, for example, a word and a phrase such as print preview, support, hot comments, no hot comments yet, etc., which are irrelevant to a main body in the webpage.

From the above three features, a threshold is obtained according to the decision tree algorithm, and nodes within the range of the threshold are all identified as a main body, and others are identified as spam words.

S106: dividing the identified main body node according to floors of the webpage, and the used method comprises division by position and division by feature word. Division by position is to perform a floor division and identification according to the path and positional relationship of a main body node on the DOM tree, and the rules which are based on when dividing are as follows.

1. if two main body nodes are adjacent to each other on the DOM tree, then the two nodes belong to one and the same floor.

As shown in FIG. 3, br represents a line break, and the br label is an empty label. The main body node 1 and the main body node 2 have a common father node div1, and the main body node 1 and the main body node 2 are adjacent to each other, and therefore the main body node 1 and the main body node 2 may be identified as nodes in one and the same floor.

2. if one main body node and other main body nodes which have already been determined as belonging to one and the same floor have a common father node, then these main body nodes belong to one and the same floor.

For example, the main body node 3 in FIG. 3 and the main body node 2, the main body node 1 have a common father node div1, and the main body node 2 and the main body node 1 have been determined as belonging to one and the same floor, therefore, the main body node 3 also belongs to the same floor.

3. if a common father node of two main body nodes is body, then the two main body nodes are divided into different floors.

For example, for the main body node 1 and the main body node 4, their paths in the DOM tree are respectively:

main body 1→div1→body

main body 4→div3→body

The common father node of their paths is body, and thereby they should be identified as being at different floors.

4. if the relationship between main body nodes is not comprised in the above situations, then they are divided into different floors.

Division by feature word is to perform a division according to a feature word in a main body. For example, a BBS main body, a news & information review, i.e. the content published by the author, is presented simultaneously together with relevant information of the author, and they appear alternately, usually as follows:

author information→main body→author information→main body→author information→main body . . .

A further “floor” division is performed on a main body by identifying a key word (e.g., publish time, register time, etc.) in a non-body node indicating the information of an author.

A mobile terminal page is generated, wherein the content of a main body node is re-laid out according to its divided floors, and then a mobile terminal page is generated. In the above process, according to the DOM tree as shown in FIG. 3, the floor distribution result of the main body nodes is as shown in FIG. 4, namely,

floor 1: main body 1, main body 2, main body 3;

floor 2: main body 4;

floor 3: main body 5, main body 6.

It should be noted that, in the individual components of the controller of the invention, the components therein are divided logically according to the functionality to be realized by them, however, the invention is not limited thereto, and the individual components may be re-divided or combined as needed, for example, some components may be combined into a single component, or some components may be further decomposed into more sub-components.

Embodiments of the individual components of the invention may be implemented in hardware, or in a software module running on one or more processors, or in a combination thereof. It will be appreciated by those skilled in the art that, in practice, some or all of the functions of some or all of the components in the system for identifying a main body of a webpage according to individual embodiments of the invention may be realized using a microprocessor or a digital signal processor (DSP). The invention may also be implemented as an apparatus or device program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

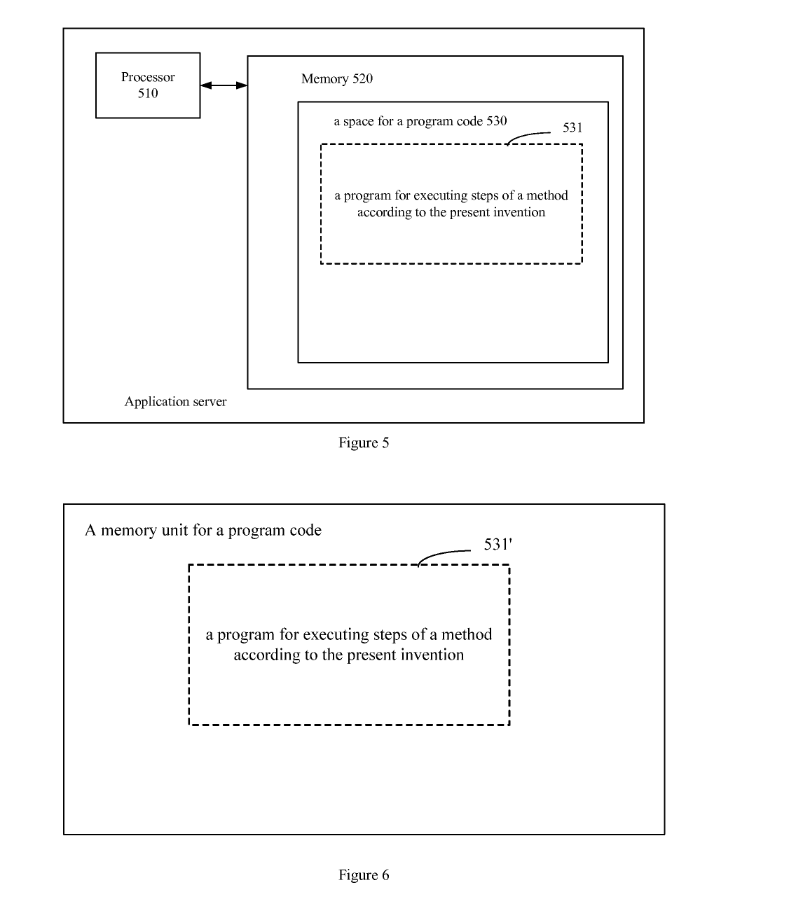

For example, FIG. 5 shows a server which may carry out the method for identifying a main body of a webpage according to the invention, e.g., an application server. The server traditionally comprises a processor 510 and a computer program product or a computer readable medium in the form of a memory 520. The memory 520 may be an electronic memory such as a flash memory, an EEPROM (electrically erasable programmable read-only memory), an EPROM, a hard disk or a ROM. The memory 520 has a memory space 530 for a program code 531 for carrying out any method steps in the methods as described above. For example, the memory space 530 for a program code may comprise individual program codes 531 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described with reference to FIG. 6. The storage unit may have a memory segment, a memory space, etc. arranged similarly to the memory 520 in the server of FIG. 5. The program code may for example be compressed in an appropriate form. In general, the storage unit comprises a computer readable code 531′, i.e., a code which may be read by e.g., a processor such as 510, and when run by a server, the codes cause the server to carry out individual steps in the methods described above.

“An embodiment”, “the embodiment” or “one or more embodiments” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several devices, several of the devices may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1. A system for identifying a main body of a webpage, comprising:
at least one processor to execute a plurality of modules comprising:
a webpage parse and layout module to parse source code of the webpage, perform a layout calculation on the parsed source code, and generate a Document Object Model (DOM) tree of the webpage;
a node identification module to traverse the DOM tree starting from a root node of the DOM tree, and identify a main body node and/or a spam word node in the DOM tree; and
a floor division module to divide the main body node according to floors of the webpage.

2. The system as claimed in claim 1, wherein each node of the DOM tree is divided according to a label in the source code of the webpage, and the root node is the main body node.

3. The system as claimed in claim 1, wherein the system comprises a mobile terminal page generation module to generate a mobile terminal page,
wherein the mobile terminal page generation module further comprises a layout generation module to re-lay out content of the main body node according to the floors of the webpage and generate the mobile terminal page.

4. (canceled)

5. The system as claimed in claim 1, wherein main elements of the webpage are preserved in the DOM tree of the webpage after the DOM tree is generated, and the main elements of the webpage comprise text, at least one link to a picture and/or a text format of the text.

6. (canceled)

7. The system as claimed in claim 1, wherein the node identification module comprises:
a statistics module to calculate a node distribution value, a text density, and/or a spam word density of the webpage;
an analysis module to analyze the node distribution value to obtain a composition of individual nodes of the webpage, and compare the text density and/or the spam word density with a corresponding preset threshold; and
a main body identification module to identify the main body of the webpage having content with the text density and/or the spam word density that falls within the corresponding preset threshold.

8. The system as claimed in claim 7, wherein
the node distribution value represents a composition of child nodes of a node, comprising a number of individual labels, and a proportion of labels in the child nodes;
the text density represents an average text length obtained by dividing a text length in a node by a number of the child nodes; and
the spam word density represents a value of a length of spam words in the node divided by a length of text in the node.

9. The system as claimed in claim 1, wherein a spam word is identified based on a dictionary.

10. The system as claimed in claim 1, wherein the floor division module comprises:
a position division module to divide a floor according to a positional relationship of the main body node on the DOM tree; and/or
a feature word division module to divide the floor according to a feature word in the webpage,
wherein the feature word comprises at least one of author information in the main body node and one of a publish time, a register time, and a news review in a non-body node.

11. The system as claimed in claim 10, wherein the position division module divides the floor based on a plurality of rules comprising:
if a first main body node and a second main body node are adjacent to each other on the DOM tree, then the first main body node and the second main body node belong to a same floor,
if one of the first main body node and the second main body node and another main body node have already been determined as belonging to the same floor and have a common father node, then the first main body node, the second main body node, and the other main body node belong to the same floor,
if the common father node of the first main body node and the second main body node is the root node, then the first main body node and the second main body node are divided into different floors, and
otherwise the first main body node and the second main body node are divided into different floors.

12. (canceled)

13. The system as claimed in claim 1, wherein the spam word node indicates a floor division of the main body of the webpage.

14. (canceled)

15. A method for identifying a main body of a webpage, comprising:
parsing, by at least one processor, source code of the webpage, performing a layout calculation on the parsed source code, and generating a Document Object Model (DOM) tree of the webpage;
traversing, the at least one processor, starting from a root node of the DOM tree, and identifying a main body node and/or a spam word node in the DOM tree; and
dividing, by the at least one processor, the main body node according to floors of the webpage.

16. The method as claimed in claim 15, wherein each node of the DOM tree is divided according to a label in the source code of the webpage, and the root node is the main body node.

17. The method as claimed in claim 15, wherein, after dividing the main body node according to the floors of the webpage, further comprising generating a mobile terminal page,
wherein generating the mobile terminal page comprises re-laying out content of the main body node according to the floors of the webpage, and generating the mobile terminal page.

18. (canceled)

19. The method as claimed in claim 15, wherein main elements of the webpage are preserved in the DOM tree of the webpage after the DOM tree is generated, and the main elements of the webpage comprise text, at least one link to a picture and/or a text format of the text.

20. (canceled)

21. The method as claimed in claim 15, wherein the identifying the main body node and/or the spam word node in the DOM tree comprises:
calculating a node distribution value, a text density, and/or a spam word density of the webpage;
analyzing the node distribution value to obtain a composition of individual nodes of the webpage, and comparing the text density and/or the spam word density with a corresponding preset threshold; and
identifying the main body of the webpage having content with the text density and/or the spam word density that falls within the corresponding preset threshold.

22. The method as claimed in claim 21, wherein
the node distribution value represents a composition of child nodes of a node, comprising a number of individual labels, and a proportion of labels in the child nodes;
the text density represents an average text length obtained by dividing a text length in the node by a number of the child nodes; and
the spam word density represents a value of the division of a length of all the spam words in a node divided by a length of text in the node.

23. (canceled)

24. The method as claimed in claim 15, wherein the dividing the main body node according to the floors of the webpage comprises:
dividing a floor according to a positional relationship of the main body node on the DOM tree; and/or
dividing the floor according to a feature word in the webpage,
wherein the feature word comprises at least one of author information in the main body node and one of a publish time, a register time and a news review in a non-body node.

25. The method as claimed in claim 24, further comprising dividing the floor according to the positional relationship of the main body node on the DOM tree based on a plurality of rules comprising:
if a first main body node and a second main body node are adjacent to each other on the DOM tree, then the first main body node and the second main body node belong to a same floor,
if one of the first main body node and the second main body node and another main body node which have already been determined as belonging to the same floor and have a common father node, then the first main body node, the second main body node, and the other main body node belong to the same floor,
if the common father node of the first main body node and the second main body node is the root node, then the first main body node and the second main body node are divided into different floors, and
otherwise the first main body node and the second main body node are divided into different floors.

26. (canceled)

27. The method as claimed in claim 15, wherein the spam word node indicates a floor division of the main body of the webpage.

28. (canceled)

29. (canceled)

30. A non-transitory computer readable medium having instructions stored thereon that, when executed by at least one processor, cause the at least one processor to perform operations for identifying a main body of a webpage, comprising:
parsing source code of the webpage, performing a layout calculation on the parsed source code, and generating a Document Object Model (DOM) tree of the webpage;
traversing the DOM tree starting from a root node of the DOM tree, and identifying a main body node and/or a spam word node in the DOM tree; and
dividing the main body node according to floors of the webpage.
